(19) United States
(12) Patent Application Publication
(10) Pub. No.: US 2017/0351470 A1
(43) Pub. Date: Dec. 7, 2017

(54) MULTI-USER DISPLAY FOR SMART SIGNS

(71) Applicant: Xevo Inc., Kirkland, WA (US)

(72) Inventors: Travis Lee BEAVEN, Woodinville, WA (US); Christi Teresa McCORKLE, Orlando, FL (US)

(21) Appl. No.: 15/175,891

(22) Filed: Jun. 7, 2016

(51) Int. Cl. G06F 3/14; G06F 3/0481; H04W 4/02; H04W 8/20

(52) U.S. Cl. CPC G06F 3/1423; H04W 8/20; G06F 3/0481; H04W 4/023

(57) ABSTRACT

Embodiments are directed towards providing a smart sign that enables multi-user interaction that is personalized for each user in proximity to the smart sign based on device-specific information obtained from the users' mobile communication devices. The smart sign determines when one or more mobile communication devices are in proximity to the smart sign. The smart sign communicates with each mobile communication device to receive device-specific information from each respective mobile communication device. The smart sign generates user-specific content for each user of each respective mobile communication device in the proximity of the smart sign. The user-specific content is displayed on the smart sign for viewing or interaction by the users. The smart sign may provide information or content back to the mobile communication device based on interactions by the user with the smart sign.

### BACKGROUND

### Technical Field

The present disclosure relates generally to the dynamic, real-time display of content on a smart sign based on information associated with users in proximity to the sign.

### Description of the Related Art

Electronic display signs are quickly replacing traditional posters and billboards as the primary way to provide information to people. Many new malls, stores, airports, stadiums, arenas, sporting venues, zoos, amusement parks, and other public places are being equipped with electronic display signs rather than relying on traditional posters and billboards to convey information to the public. These electronic display signs allow an advertiser or merchant to change the information that is being displayed from week-to-week, day-to-day, or even hour-to-hour, but the information is often static and targeted to a general audience while it is being displayed. It is with respect to these and other considerations that the embodiments described herein have been made.

### BRIEF SUMMARY

Briefly stated, embodiments are directed towards providing a smart sign that enables multi-user interaction that is personalized for each user in proximity to the smart sign based on device-specific information obtained from their respective mobile communication devices. The smart sign determines when one or more mobile communication devices are in proximity to the smart sign, e.g., within a field-of-view area of the smart sign. In various embodiments, a mobile communication device may be in the proximity of the smart sign when the mobile communication device is within a predetermined distance from the smart sign, communicating with the smart sign, or a user of the mobile communication device is interacting with the smart sign. The smart sign communicates with each of these mobile communication devices to receive device-specific information from each respective mobile communication device. The smart sign generates user-specific content for each user of each respective mobile communication device in the proximity of the smart sign. In various embodiments, the smart sign can generate a customized user experience or graphical user interface with the user-specific content for each respective user. The user-specific content is then displayed on the smart sign. In various embodiments, a location of the mobile communication devices relative to the smart sign or to each other may be determined and used to graphically position the user-specific content on the smart sign to be closer the respective user.

In a non-exhaustive example, the smart sign displays visual content for users to view, interact with, or otherwise consume. When the smart sign determines that a first and second mobile communication device are in a field-of-view area of the smart sign, the smart sign communicates with both mobile communication devices to obtain first device-specific information from the first mobile communication device and second device-specific information from the second mobile communication device. The smart sign then generates first user-specific content based on the first device-specific information and second user-specific content based on the second device-specific information. The first user-specific content is personalized for a first user of the first mobile communication device and the second user-specific content is personalized for a second user of the second mobile communication device.

The displayed visual content is customized to include the first user-specific content and the second user-specific content, which are both displayed concurrently to the users. In some embodiments, the user-specific content may be displayed separate from the initially displayed content. In other embodiments, the user-specific content may be added to the initially displayed content or the initially displayed content may be otherwise modified to include or incorporate the user-specific content. In various embodiments, a separate graphical user experience or interface is displayed on the smart sign for each user, where each separate graphical user experience or interface includes the user-specific content for each respective user. In some embodiments, the initially displayed content may be incorporated into each separate graphical user experience or interface, while in other embodiments, the separate graphical user experience or interfaces may be separate from the initially displayed content.

When all users leave the proximity of the smart sign, the initially displayed visual content is redisplayed on the smart sign without any user-specific content. If a user leaves the proximity of the smart sign while other users are still in the proximity of the smart sign, the user-specific content for the user that left the proximity is removed from the customized content while maintaining the user-specific content for the users that are still in the proximity of the smart sign.

In some embodiments, a user may interact with the smart sign, such as by touching the display screen of the smart sign. This interaction may be with the initially displayed content or it may be with the user-specific content that is displayed. In various embodiments, the smart sign can modify the user-specific content in which the user interacted based on the user's interactions with the smart sign. In at least one embodiment, the other user-specific content that was not interacted with by the user may not be modified. In some embodiments, the smart sign may perform one or more additional actions based on the interaction. In various embodiments, the smart sign provides information associated with the interaction or in response to the additional actions to the user's mobile communication device that is associated with the user-specific content that was interacted with by the user.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment where a dynamic smart sign communicates with multiple mobile communication devices that are in close proximity to the sign to provide a multi-user display in accordance with embodiments described herein;

FIGS. 2A-2C show use case examples of a field-of-view area for a dynamic smart sign in accordance with embodiments described here;

FIGS. 3A-3E show use case examples of a multi-user display on a smart sign in accordance with embodiments described herein;

FIG. 4 illustrates a logical flow diagram generally showing one embodiment of an overview process for providing a multi-user display on a smart sign based on the device-specific information associated with one or more mobile communication devices in close proximity to the sign in accordance with embodiments described herein;

FIG. 5 illustrates a logical flow diagram generally showing one embodiment of a process for selecting the graphical position of user-specific content to display on the multi-user display on the smart sign in accordance with embodiments described herein;

FIG. 6 illustrates a logical flow diagram generally showing one embodiment of a process for receiving user interactions with a multi-user display and performing actions based on those interactions in accordance with embodiments described herein; and

FIG. 7 shows a system diagram that describes one implementation of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

The terms “smart sign,” dynamic smart sign,” “electronic display sign,” or “sign” refer to a display device that can detect mobile communication devices that are in a close proximity to the device and dynamically change the content being displayed on the device based on device-specific information or other characteristics of the detected mobile communication devices. Smart signs may be standalone devices or they may be combined with other electronic devices, and they may be employed in a variety of different situations, settings, or environments. For example, in some embodiments, smart signs may include freestanding or wall hanging smart signs used in malls, stores, airports, stadiums, arenas, sporting venues, zoos, amusement parks, hotel lobbies, cruise ships, retail shops, or other locations where information is provided to people. In some other embodiments, the smart signs may be utilized in other electronic devices, such as, but not limited to, a head unit in an automobile, a television in a hotel room or cruise-ship cabin, a heads-up display in an airplane seat, or other electronic devices.

The term “content” refers to information that can be displayed on a smart sign. Content may include visual content, such as, but not limited to, text, graphics, symbols, video, or other information that is provided to a user on the smart sign. In some embodiments, the content may also include audio content. Examples of content can include, but are not limited to, advertisements, athlete information, directions, restaurant menus, descriptive information, emergency instructions, etc. User-specific content refers to content that is selected, modified, generated, or otherwise determined for a specific user based on device-specific information obtained from a mobile communication device of that user. User-specific content can be overlaid or added to the default content of a smart sign, supplement the default content of the smart sign, replace the default content or other content on the smart sign, or otherwise displayed on the smart sign.

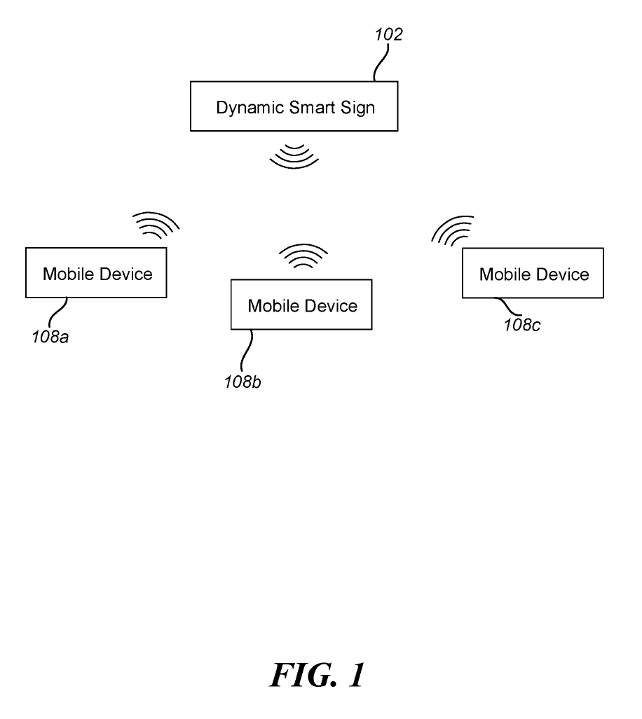

FIG. 1 illustrates a context diagram of an environment where a dynamic smart sign communicates with multiple mobile communication devices that are in close proximity to the sign to provide a multi-user display in accordance with embodiments described herein. Environment 100 includes a dynamic smart sign 102 and a plurality of mobile communication devices 108a-108c, also referred to as mobile devices.

The dynamic smart sign 102 can communicate with one or more mobile communication devices 108 as those mobile communication devices enter or come into close proximity to the dynamic smart sign 102. In the illustration, the dynamic smart sign 102 is communicating with mobile communication devices 108a, 108b, and 108c. It should be understood that at any given point in time, the dynamic smart sign 102 may be communicating with zero, one, or a plurality of mobile communication devices that are in proximity to the dynamic smart sign 102. Similarly, there may be a plurality of dynamic smart signs (not illustrated) that each communicate with one or more mobile communication devices that are in proximity to each respective smart sign.

The dynamic smart sign 102 obtains device-specific information from the mobile communication device 108a-108c. The dynamic smart sign 102 utilizes the device-specific information of each mobile communication device 108 that is in its proximity to display user-specific content on the dynamic smart sign 102 to the users of the mobile communication devices 108.

In various embodiments, the dynamic smart signs 102 may also determine a location of each mobile communication device 108. For example, the dynamic smart sign 102 determines the location of mobile communication devices 108a, 108b, and 108c relative to dynamic smart sign 102. The dynamic smart sign 102 utilizes this location information to modify one or more visual characteristics of the user-specific content, including, but not limited to determining a graphical display position or size to render the user-specific content for the corresponding mobile communication devices 108. In this way, the dynamic smart sign 102 displays content closer to the user of a mobile communication device 108, which allows for the user to more easily interact with the dynamic smart sign 102.

The mobile communication device 108 can be a cell phone; mobile phone; smart phone; tablet computer; portable personal computer; Wi-Fi, Bluetooth, or other short range communication enabled electronic device; or any other electronic device that is mobile an can communicate by some wireless method with other devices.

In some embodiments, the dynamic smart sign 102 communicates with a content server (not illustrated). The dynamic smart sign 102 can receive content from the content server or provide device-specific information regarding the mobile communication devices in its proximity to the content server. Examples of such information may include, but are not limited to, a preferred language of the mobile communication devices, mobile applications that are sharing information, number of mobile communication devices that interact with the smart sign, or other information or analytical data associated with the users interacting with the smart sign. In various embodiments, dynamic smart sign 102 may communicate with the content server via a communication network (not illustrated). The communication network may be configured to couple various computing devices to transmit data from one or more devices to one or more other devices. The communication network includes various wired or wireless networks that may be employed using various forms of communication technologies and topologies, such as, but not limited to, cellular networks, mesh networks, or the like.

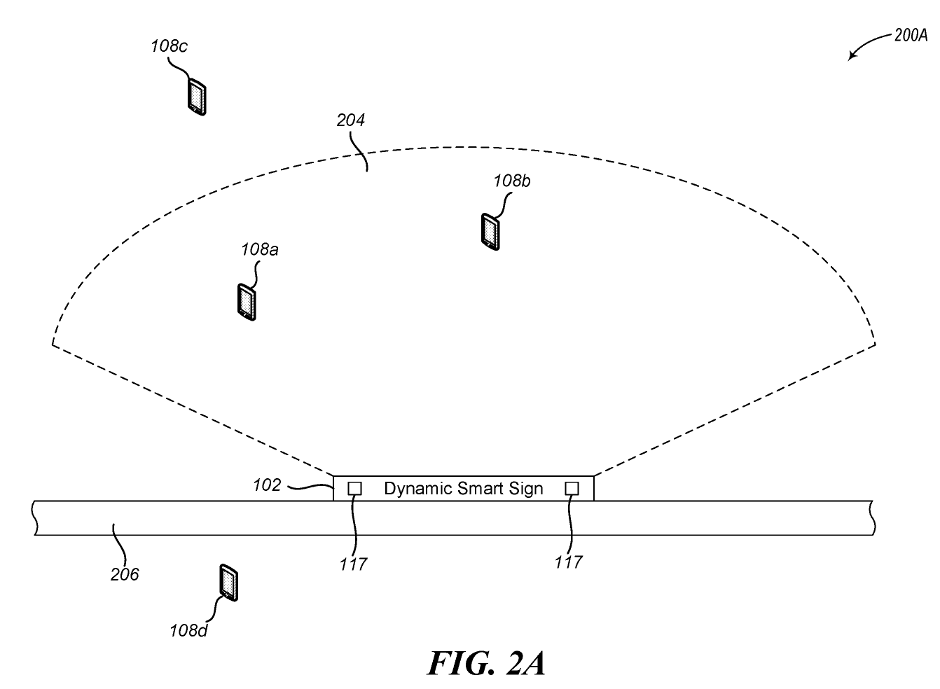

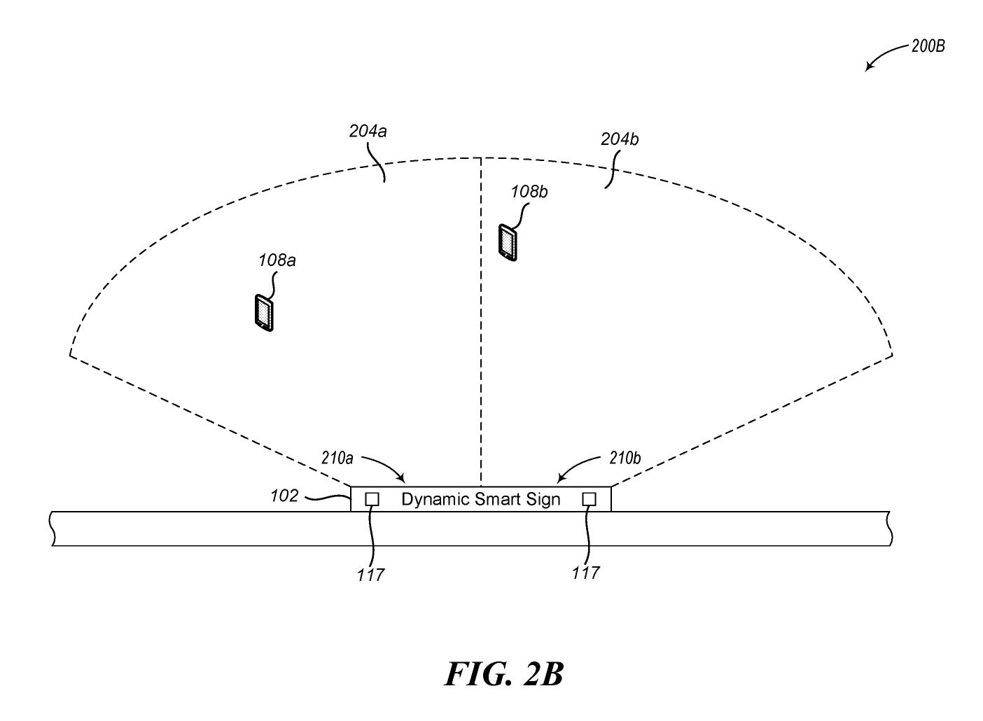

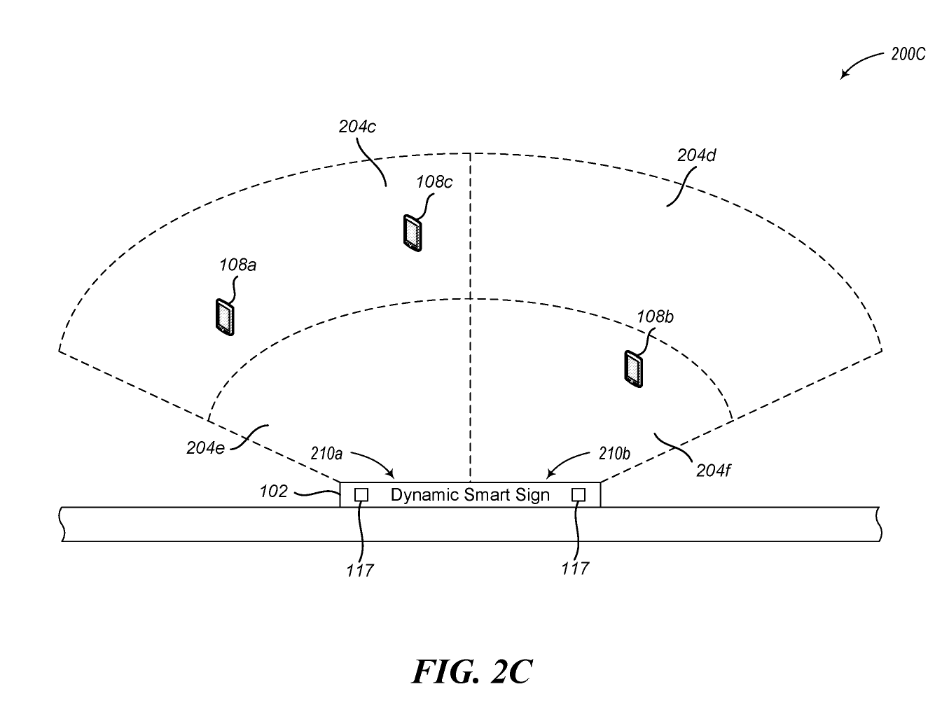

FIGS. 2A-2C show use case examples of a field-of-view area for a dynamic smart sign in accordance with embodiments described here. FIG. 2A illustrates an example 200A of a dynamic smart sign 102 with a field-of-view area 204. The field-of-view area 204 is a distance or area in which the smart sign 102 can detect, track, or communicate with a mobile communication device 108. In various embodiments, the field-of-view area 204 is a distance or area in which a user of a mobile communication device 108 can see, view, hear, interact with, or otherwise digest the content provided by the smart sign 102.

The field-of-view area 204 may be defined or identified as a predetermined distance from the smart sign 102, an area defined relative to the smart sign 102, when a mobile communication device 108 is within communication range of the smart sign 102 via a short-range communication technology, or other spatial relationship between the smart sign 102 and the mobile communication device 108, or a combination thereof.

In some embodiments, a user is in the field-of-view area 204 when the user touches or otherwise interacts with the smart sign 102. In at least one of various embodiments, the smart sign 102 may determine the location of the user relative to the smart sign 102 based on where the user touches the smart sign 102. In various embodiments, the smart sign 102 may not communicate with the mobile communication devices 108 in the field-of-view area 204 until a user touches or otherwise interacts with the smart sign 102, such as by talking to the smart sign 102 or having the mobile communication device 108 provide information to the smart sign 102 in response to a user input on the mobile communication device 108. Once the user interacts with the smart sign 102, the smart sign 102 initiates communications between the smart sign 102 and the mobile communication device 108 of the user. The mobile communication device 108 provides its device-specific information to the smart sign 102. And the smart sign generates and displays user-specific content to the user while the user continues to interact with the smart sign 102 or for a predetermined period of time. Similarly, the smart sign 102 can remove the user-specific content from the display of the smart sign 102 after a predetermined time period has lapsed since the user last interacted with the smart sign 102. In various embodiments, the smart sign 102 may periodically, at predetermined times, or randomly communicate with the mobile communication devices 108 in the field-of-view area 204 to determine if the same user is interacting with the smart sign or if the user has exited the field-of-view area 204.

In some embodiments, the field-of-view area 204 may be defined as a distance from the smart sign 102. In at least one embodiment, the smart sign 102 can determine the distance or location of a mobile communication device 108 relative to the smart sign 102 using the round-trip time of communications sent between the smart sign 102 and the mobile communication device 108, ultrasonic sensors, or other sensors that detect a distance between two communicating devices known to one skilled in the art. This detected distance can then be compared to the distance that defines the field-of-view area 204, and if the detected distance is within the field-of-view area 204, then the mobile communication device is in the proximity of the smart sign, otherwise it is not.

In other embodiments, the field-of-view area 204 may be a defined spatial area in a particular position relative to the smart sign 102. For example, the field-of-view area 204 may be defined as the area in front of the smart sign 102, but within a predefined radial distance away from the smart sign 102, such as is illustrated in FIG. 2A. In at least one embodiment, the smart sign 102 can determine if a mobile communication device 108 is within the field-of-view area 204 by employing one or more directional proximity detectors 117 or sensors to determine a location of the mobile communication device 108 relative to the smart sign 102. In some embodiments, the relative location of each mobile communication device may be a radial angle or other coordinate system directions that have a corresponding graphical display location.

In yet other embodiments, the field-of-view area 204 may be defined as the area in which a mobile communication device 108 can communicate with the smart sign 102. In this way, a mobile communication device 108 is in proximity to the smart sign 102 when the mobile communication device 108 is within communication range of the smart sign 102 via a short-range communication technology. In various embodiments, the smart sign 102 is configured to receive signals from or communicate with mobile communication devices 108 via one or more short-range communication technologies, such as via Near Field Communication (NFC) protocols, Bluetooth Low Energy (BLE) protocols, Radio-frequency identification (RFID) technology, or other short-range communication technologies. Receipt of a message or signal from a mobile communication device 108 using a short-range communication technology may indicate that the mobile communication device 108 is in the field-of-view area 204 of the smart sign 102.

Various range and directional proximity detectors 117, sensors, devices, technologies, or mechanisms known to those skilled in the art can be used to logically define or identify the field-of-view area 204. For example, such proximity detectors are widely used in cars for detecting mobile devices both inside and outside but proximate to the car. It should be noted that one or more proximity detectors 117 may be built into the smart sign 102 or positioned remote to the smart sign but in a way that can define the field-of-view area 204, such as in or on an adjacent or nearby wall, pillar, or fixture, or even in the ceiling or floor. Similarly, it should be noted that the field-of-view area 204 may take on various geometrical shapes, such as circular, semicircular, rectangular, triangular, or other polygons. The shape the field-of-view area 204 may be determined based on the type of sensors or technology used to detect or communicate with the mobile communication devices 108, the number of sensors used, or the positioning of the sensors relative to each other or the smart sign 102.

In various embodiments, the field-of-view area 204 may be preset by an administrator or determined by the smart sign. In at least one embodiment, the smart sign may utilize ultrasonic sensors, rangefinders, or other sensors to determine the environment around the smart sign, such as walls, hallways, etc., to determine the field-of-view area 204, such as at what distance or area can a user properly view the smart sign 102.

In other embodiments, the field-of-view area 204 is pre-determined or set by an administrator based on the purpose of the smart sign 102, what content is being displayed on the smart sign 102, the location of the smart sign 102, or other environmental factors associated with the smart sign 102. For example, in some situations, the smart sign 102 may be in a location where it only wants to provide user-specific content to those users that are within arm's reach of the smart sign 102 or who are actually interacting, e.g., touching, with the smart sign, such as in an airport. In this type of situation, the smart sign 102 would only want to obtain device-specific information from the mobile communication devices 108 that are in front of and less than a meter away from the smart sign and not behind or to the side of the smart sign 102. In other situations, the smart sign may want to provide user-specific content to those users that are within arm's reach of the smart sign 102 or at least within a few meters of the smart sign 102, such as in a hotel room or cruise-ship cabin. In this type of situation, the smart sign 102 would only want to obtain the device-specific information from mobile communication devices 108 in that particular room or cabin and not in an adjacent room or cabin, or even in the hall.

In some other situations, the smart sign 102 may be in a location where it wants to obtain device-specific information from mobile communication devices that are within a predetermined distance in all directions around the smart sign 102, such as in a football stadium. In this type of situation, the smart sign 102 may be positioned on a pillar in the middle of a corridor in the football stadium. In this example, the smart sign 102 may want to obtain the device-specific information from the mobile communication devices 108 that are all around the sign, even if a user of a mobile communication device 108 is not directly in front of the sign 102.

By collecting the device-specific information from mobile communication devices 108 that are in the field-of-view area 204, whether in front of or behind the smart sign 102, the smart sign 102 can perform additional analytics or operations based on the obtained device-specific information. For example, in some embodiments, the smart sign 102 can pre-generate user-specific content in anticipation of a mobile communication device 108 moving from behind the sign 102 to the front of the sign 102, the smart sign 102 can inform other smart signs of the device-specific information of mobile communication devices that may enter the field-of-view area of those other signs, or the smart sign 102 may modify its own default content based on the device-specific information, as described elsewhere herein.

It should be noted that, in some embodiments and situations, the users of the mobile communication devices 108 may be able to view the content on the smart sign 102 before they enter the field-of-view area 204, but that the field-of-view area 204 is some defined area that when a mobile communication device 108 enters this area, the smart sign displays the user-specific content for that mobile communication device. For example, a large sign in a mall could be viewed by a lot of people that are very far away from the sign, but the sign will only display the user-specific content for those people that are closer to the sign. In some embodiments, the size of the field-of-view area 204 may be defined by an administrator or limited by the technology utilized to detect or communicate with the mobile communication devices.

As illustrated in FIG. 2A, the smart sign 102 is attached to a wall 206, such as in an airport. The illustrated field-of-view area 204 is an area that is substantially in front the smart sign 102 and has a specific radius from the center of the smart sign 102. In this example, the field-of-view area 204 is semicircular so as to detect mobile communication devices 108 that are substantially in front of the smart sign 102, but not behind the wall 206.

As shown, mobile communication devices 108a-108c are substantially in front of the smart sign 102 and mobile communication device 108d is behind the wall 206, such as in another room. In this case, mobile communication devices 108a and 108b are within the field-of-view area 204 and can be detected or tracked by, or communicate with, the smart sign 102, while mobile communication devices 108c and 108d are outside the field-of-view area 204 and cannot be detected or tracked by, or communicate with, the smart sign 102. Accordingly, the smart sign 102 is unaware of the presence or location of the mobile communication devices 108c and 108d. However, if mobile communication device 108c is moving towards the smart sign 102, the smart sign 102 should be able to detect and communicate with the mobile communication device 108c once it enters the field-of-view area 204.

When a mobile communication device 108 enters the field-of-view area 204, the dynamic smart sign 102 obtains device-specific information from the mobile communication device 108. A user of the mobile communication device 108 presets various permissions and settings of the mobile communication device and the applications on the mobile communication device to share and receive information from other devices, such as smart sign 102. For example, when the user downloads an application for the coffeehouse chain Coffee_A, the user can opt in to receive alerts on the mobile communication device whenever the mobile communication device is near a Coffee_A location. In another example, the mobile communication device may include an application that allows the user to input and store ticket information for airplane boarding passes, train tickets, event tickets, or other e-tickets that can be used to gain entry without the use of a paper ticket. Again, the user can opt in to have this information shared with other computing devices, or the user can opt in to enable other computing devices to change this information. Although these examples refer to the user having to opt in to have the mobile communication device share and receive information from other computing devices, embodiments are not so limited, and some applications or information may be automatically shared or enabled to receive information from other computing devices, such as smart sign 102.

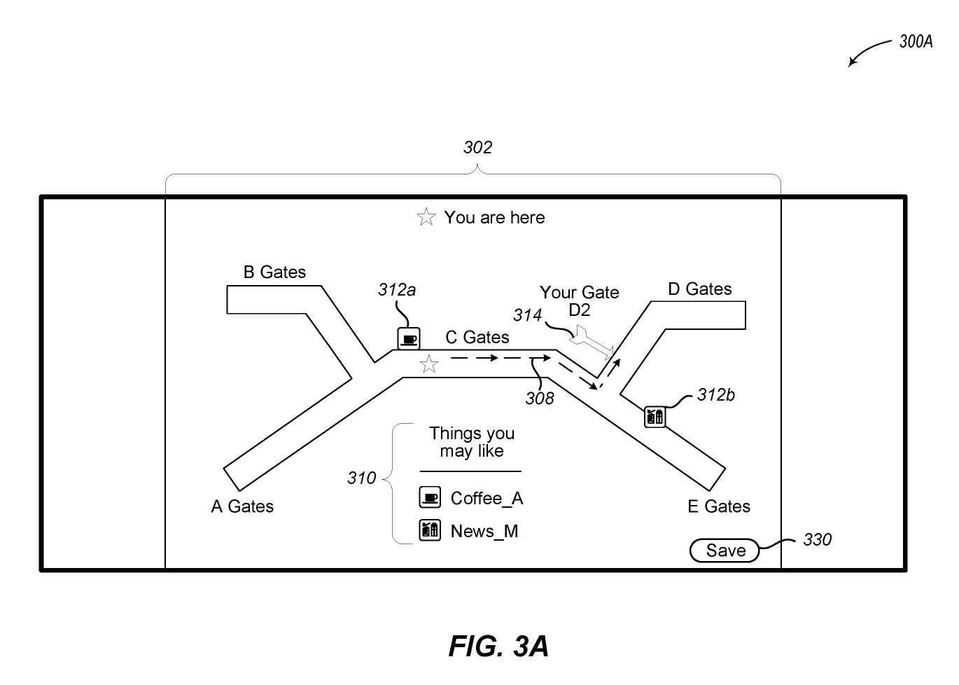

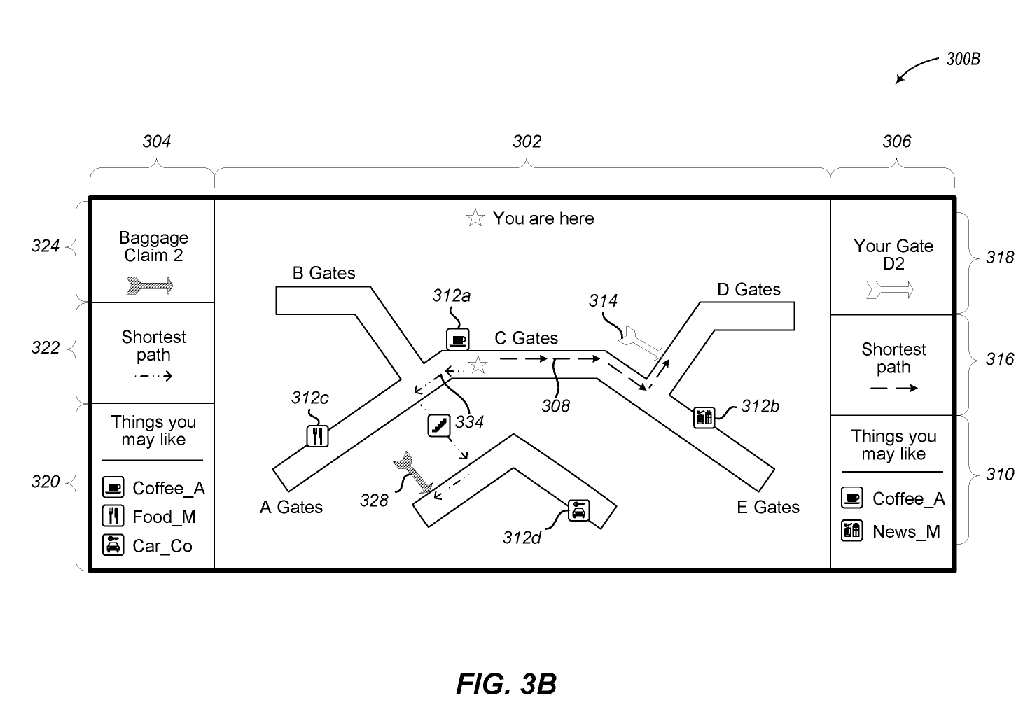

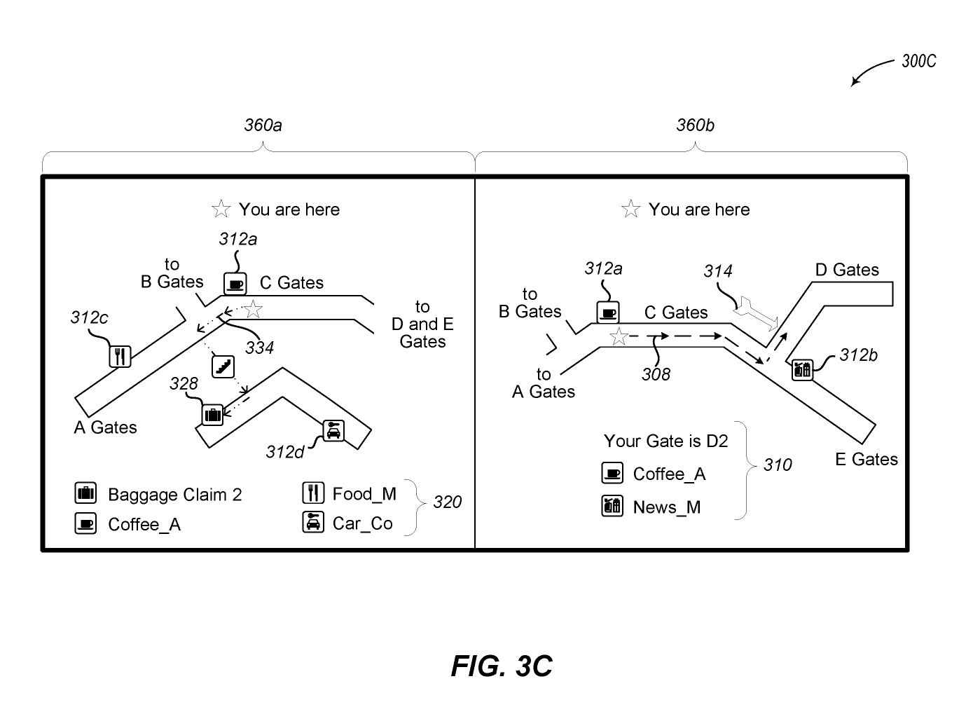

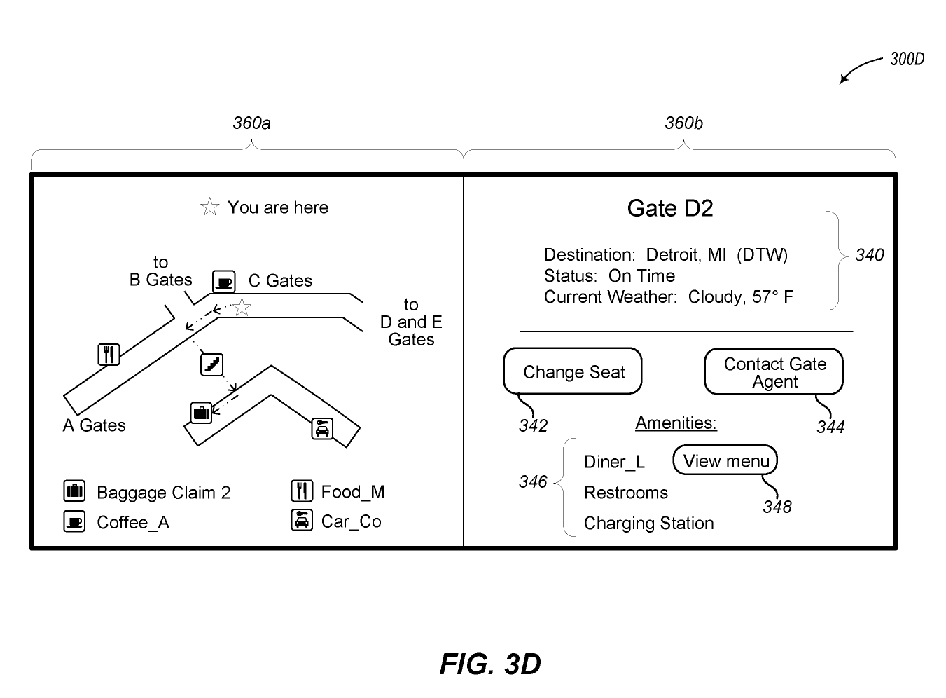

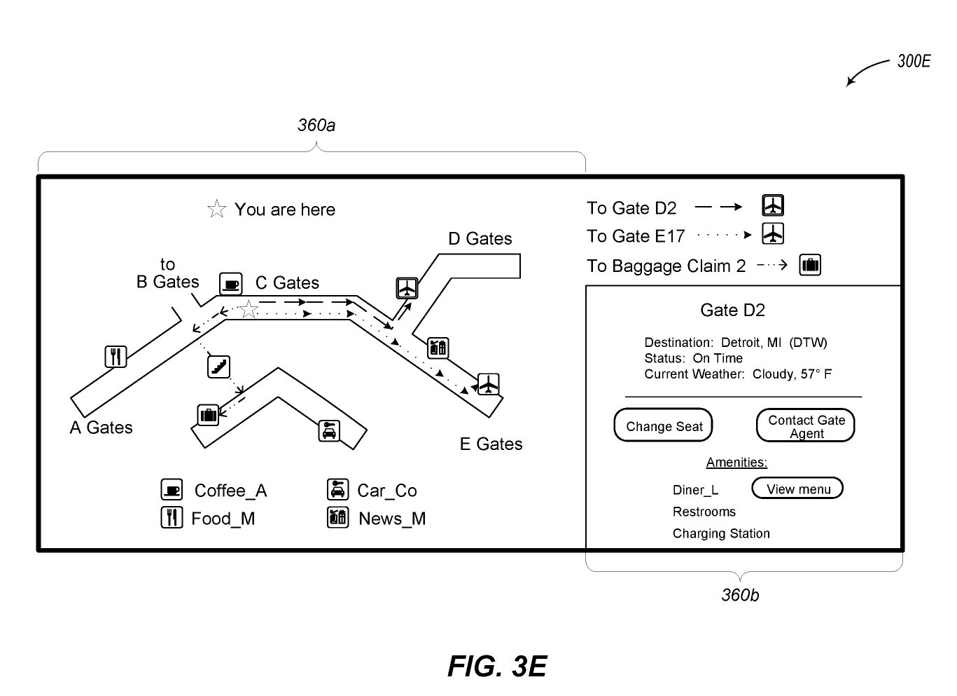

The smart sign 102 generates user-specific content based on the received device-specific information from the mobile communication device 108. In some embodiments, generating the user-specific content may include adding additional content to default content of the smart sign. For example, assume the smart sign is a map of an airport terminal. The smart sign may receive the boarding pass information for the user from his mobile communication device. The smart sign can look up the gate information associated with the flight information in the boarding pass. The smart sign then displays the location of the gate on the map and fastest route to the gate from the smart sign, i.e., the user's current location, such as is illustrated in FIG. 3A. The smart sign might also receive information from the mobile communication device that the mobile communication device has the Coffee_A application installed and can share information. The smart sign can determine where there is a Coffee_A location in the airport terminal, and if there is a location, the map can be updated to include an icon showing where the coffeehouse is in the terminal, hours of operations, coupon information, menu items, or other information associated with Coffee_A.

Since the smart sign 102 can track multiple mobile communication device 108, the smart sign 102 is enabled to have multiple users interact with the smart sign at a given point in time. For example, continuing the airport terminal map example from above, when a second mobile communication device enters the field-of-view area 204 and the smart sign receives its device-specific information, the smart sign can display separate content that is specific for each separate user concurrently with each other, and in some embodiments concurrently with displaying content for other users. In some embodiments, the sign may display the map in a central portion of the display screen of the sign with various information highlighted based on the device-specific information of each mobile communication device. The sign may also display separate interactive portions on the display screen of the sign that are specific for each separate user, such as is illustrated in FIG. 3B. In this way, both of these users and other users can still view the map while also providing specific information to each user concurrently. In other embodiments, the sign may generate separate maps for each user, such as is illustrated in FIGS. 3C-3D. In this example, each user can separately manipulate their specific content and interact with the sign, which provides for a unique and specialized experience for each user without being impacted by the other user. So, if one user has to go to Gate D2 and the other user has to go to baggage claim, each separate map can be tailored and customized for each respective user based on the device-specific information received from each respective mobile communication device.

It should be noted that the smart sign may display default content that can be viewed by any user, regardless of whether the smart sign has received any device-specific information from their mobile communication devices. The user-specific content can be added to the default content, such as by adding icons, symbols, arrows, or other information to the default content. In other embodiments, the user-specific content may be separately generated content. For example, an advertisement can be generated that is customized for the user, such as by using the user's age, gender, preferred language, application information, or other personal information that is obtained from the user's mobile communication device.

As mentioned above, the field-of-view area 204 is the area in which the smart sign 102 can detect, track, or communicate with a mobile communication device 108. The field-of-view area 204 may be directional, such as illustrated in FIG. 2A, or it may encompass multiple directions around a smart sign 102, such as 360 degrees. In some embodiments, the smart sign 102 may also employ a proximity area (not illustrated) that may partially or fully overlap the field-of-view area 204 or it may be a completely separate area that is remote to the field-of-view area 204 and the smart sign 102. The proximity area allows the smart sign 102 to detect and track mobile communication devices 108 before they enter the field-of-view area 204. For example, if a mobile communication device 108 is within the proximity area and not yet in the field-of-view area 204 of the smart sign 102, then the smart sign 102 can obtain the device-specific information from that mobile communication device 108 and generate or display the user-specific content prior to the mobile communication device 108 entering the field-of-view area 204.

In some embodiments, the field-of-view area 204 or the proximity area may be utilized to track the movement of mobile communication devices within those areas. In this way, the smart sign 102 can determine if a mobile communication device 108 is moving in a direction towards the field-of-view area 204 or moving out of the field-of-view area 204. The smart sign 102 can also utilize the direction of travel and rate of movement to determine if it will adjust the displayed content. For example, if mobile communication device 108b is moving very slowly away from the smart sign 102 and out of the field-of-view area 204, then this slow movement rate may indicate that the user of the mobile communication device 108b is simply backing up rather than walking away from the sign. In contrast, if mobile communication device 108a is moving very quickly through the field-of-view area 204 and away from the smart sign 102, then this fast movement away from the smart sign 102 may indicate that the user of the mobile communication device 108a is walking away from the sign rather than stopping to interact with the smart sign 102. In this way, the smart sign 102 may maintain the user-specific content for mobile communication device 108b, but not add the user-specific content for mobile communication device 108a.

In some other embodiments, the proximity area may be remotely located from the field-of-view area 204 such that they do not overlap at all. For example, the system may include a first proximity detector that is remote from the smart sign 102, which is used to obtain the device-specific information from a mobile communication device 108 and provide it to the smart sign 102. The smart sign 102 may include a second proximity detector to determine when the mobile communication device 108 actually enters the field-of-view area 204, at which point the smart sign 102 displays the user-specific content based on the obtained device-specific information.

One example use case of this type of non-overlapping proximity area and field-of-view area 204 may be in an elevator in a hotel or cruise ship. The proximity area may be in the elevator itself and the field-of-view area 204 may be the hallway in front of the smart sign directly outside the elevator. As a user rides the elevator, the system obtains the device-specific information from mobile communication device of the user and generates user-specific content based on the device-specific information. Once the elevator arrives at the floor with the smart sign, the smart sign displays the user-specific content, such as where the user's cabin is located relative to the smart sign. Since the user may only be in front of the sign for a short period of time, any delays in generating the user-specific content can result in the user missing the content or forcing the user to pause and wait for the sign to update with the user-specific content. This type of remote, two-stage tracking can improve the user's experience by reducing visual delays in displaying the user-specific content. It should be understood that this two-stage tracking can also be performed when the proximity area is larger than the field-of-view area 204 or where the proximity area overlaps but extends beyond the field-of-view area 204.

FIG. 2B illustrates an example 200B of a dynamic smart sign 102 with a field-of-view area 204. Example 200B is a further illustrative embodiment of example 200A in FIG. 2A, but with the field-of-view area 204 logically separated into multiple portions or sections.

As illustrated, the field-of-view area 204 is separated into field-of-view-area sections 204a and 204b. In this example, the field-of-view-area section 204a is on the right-side of the smart sign 102 and the field-of-view-area section 204b is on the left-side of the smart sign 102, from the perspective of the users viewing the smart sign 102.

In various embodiments, each field-of-view-area section may be associated with a display position on the smart sign 102 so that the rendered content is closer to users in that section. As illustrated, the field-of-view-area section 204a is associated with a right side 210a of the smart sign 102 and the field-of-view-area section 204b is associated with a left side 210b of the smart sign 102, from the perspective of the users viewing the smart sign 102.

Each mobile communication device in the field-of-view area 204 may be assigned a field-of-view-area section based on their actual locations relative to the smart sign 102. For example, mobile communication device 108a is located in and assigned to the field-of-view-area section 204a, and mobile communication device 108b is located in and assigned to the field-of-view-area section 204b. By employing embodiments described herein, user-specific content for the mobile communication device 108b is generated based on device-specific information obtained from the mobile communication device 108b and displayed on the left side 210b of the display screen of the smart sign 102, and user-specific content for mobile communication device 108a is generated based on device-specific information obtained from the mobile communication device 108a and displayed on the right side 210a of the display screen of the smart sign 102, both being from the perspective of the users, such as illustrated in FIGS. 3B or 3C.

Although the above example relies on left- and right-field-of-view-area sections, embodiments are not so limited. For example, if both users are in the field-of-view-area section 204a but it is determined that a first user is standing to the right of a second user, from the perspective of the smart sign 102, then, similar to the previous example, the user-specific content for the first user should be displayed on the left side 210b of the display screen and the user-specific content for the second user should be displayed on the right side 210a of the display screen, both being from the perspective of the users. Similarly, if one user is further away from the smart sign 102, then the user-specific content for that user can be displayed differently than the user-specific content for a user that is standing right next to the sign, such as is illustrated in FIG. 3E.

It should be recognized that embodiments are not limited to logically separating the field-of-view area 204 into only one or two sections. Rather other numbers and arrangements of logical-field-of-view-area sections may be utilized. For example, the smart sign may utilize two or more lateral sections, two or more medial sections, or a combination thereof.

For example, FIG. 2C illustrates an example 200C of a dynamic smart sign 102 with a field-of-view area 204 that is logically separated into four, quadrant-like field-of-view-area sections 204c-204f. Similar to what is described above, the field-of-view-area sections may be utilized to position the user-specific content on the smart sign, as well as to modify the display size of the user-specific content based on which field-of-view-area section a mobile communication device is located.

In this illustration, the mobile communication devices 108a and 108c are located in and assigned to the field-of-view-area section 204c and the mobile communication device 108b is located in and assigned to the field-of-view-area section 204f. Since the mobile communication device 108b is closer to the smart sign 102, and the user of that device may be already interacting with the smart sign 102, the user-specific content generated for the user of the mobile communication device 108b can be displayed on the left side 210b of the display screen of the smart sign 102, from the perspective of the users, so that it is closer to the user for easier viewing and interaction. However, since the mobile communication devices 108a and 108c are further from the smart sign, and their users may be only viewing the smart sign and not directly touching or interacting with the smart sign, the user-specific content generated for the users of the mobile communication devices 108a and 108c can be combined or separately displayed on the right side 210a of the display screen of the smart sign 102, from the perspective of the users. In this way, the user-specific content for the users of the mobile communication devices 108a and 108c may still be viewable to those users without interfering with the user-specific content for the user of the mobile communication device 108b.

In various embodiments, the dynamic smart sign 102 may continuously utilize a specific pattern or arrangement of field-of-view-area sections, such as illustrated in FIGS. 2A-2C. In some embodiments, the field-of-view-area sections may change based on the number of mobile communication devices that enter the sections over time. For example, if no mobile communication devices enter a particular section over a one-week period, then there may be an obstacle or obstruction preventing mobile communication devices from entering that area. In response, the dynamic smart sign may adjust the field-of-view-area sections to remove that section or merge it with one or more other sections. The modifications to the various sections may be made in an attempt to balance the number of mobile communication devices for each section over a given period of time, which can provide a more uniform, attractive, and user-friendly display when multiple users are interacting with the smart sign.

In yet other embodiments, the dynamic smart sign 102 may utilize one or more field-of-view-area sections based on the number of mobile communication devices that are in the field-of-view area. For example, if there is only one mobile communication device in the field-of-view area, then only a single section may be utilized, such as illustrated in FIG. 2A. But if another mobile communication device enters the field-of-view area, then a second section may be added, such as illustrated in FIG. 2B. Similarly, if a third mobile communication device, or more, enters the field-of-view area, then the smart sign may utilize a more grid-like pattern, similar to what is illustrated in FIG. 2C. As a result, the number and arrangement of field-of-view-area sections may dynamically change based on the number of mobile communication devices in the field-of-view area.

FIGS. 3A-3E show use case examples of a multi-user display on a smart sign in accordance with embodiments described herein. FIG. 3A illustrates an example display 300A of a smart sign, such as smart sign 102. In this example, the smart sign is displaying a map of an airport terminal in a central content window 302.

By employing embodiments described herein, the smart sign detects that a first mobile communication device in its proximity and obtains first device-specific information from the first mobile communication device. For example, assume the first device-specific information includes boarding pass information, an indication that the application for Coffee_A is installed on the first mobile communication device, and the first mobile communication device has multiple newspaper subscriptions. By comparing this information to known information about the airport, the smart sign determines the gate of departure for the first user's flight, identifies a Coffee_A location in the airport, and identifies a News_M stand that may sell newspapers.

The smart sign generates first user-specific content based on the first device-specific information, such as an items-of-interest list 310, icons 312, and an arrow 314. The smart sign adds the first user-specific content to the map in the central content window 302, so that the map includes the items-of-interest list 310, icon 312a at the relative location of Coffee_A, and icon 312b at the relative location of News_M. The arrow 314 and route 308 are also added to the map so that the first user can see the fastest way to the first user's gate from the first user's current location.

As described herein, the smart sign may provide information back to the user's mobile communication device based on the user-specific content or interactions between the user and the smart sign. In this example, the user can click button 330 to instruct the smart sign to provide a screenshot of the map, along with the first user-specific content, to the first user's mobile communication device. The first user's mobile communication device may store this information so that the first user can reference the map without having to find another smart sign that can display the map.

FIG. 3B illustrates an example display 300B of the smart sign. Example 300B is a further illustrative embodiment of example 300A in FIG. 3A, but where there are two users in the proximity of the smart sign.

By employing embodiments described herein, the smart sign may detect that a second mobile communication device in now its proximity along with the first mobile communication device. In this example, the smart sign obtains second device-specific information from the second mobile communication device. For example, assume the second device-specific information includes boarding pass information, an indication that the applications for Coffee_A and Food_M are installed on the second mobile communication device, and the second mobile communication device is storing rental car confirmation information. Again, by comparing this information to known information about the airport, the smart sign determines the second user's flight has landed and also determines the baggage claim number, identifies a Coffee_A location in the airport, identifies a Food_M location in the airport, and identifies the location of the rental-car-company desk in the airport.

In this example, the smart sign generates a first-user content window 306 and a second-user content window 304. The first-user content window 306 includes at least some of the first user-specific content for the first user, such as the items-of-interest list 310, information 318 identifying the user's gate number and the arrow symbol indicating where the gate is located, and a key 316 illustrating the symbol used for the route 308 from the first user's current location to the gate. The second-user content window 304 includes at least some of the second user-specific content for the second user, such as items-of-interest list 320, information 324 identifying the baggage claim number and the arrow symbol indicating where the gate is located, and a key 322 illustrating the symbol used for route 334 from the second user's current location to the baggage claim.

The smart sign may also display the initial content, i.e., the map, which may or may not include additional user-specific information. In this illustration, the icons, 312, arrows 314 and 328, and routes 308 and 334 are illustrated on the map to indicate where the various items of interest, the first user's gate, and the second user's baggage claim are located.

FIG. 3C illustrates an example display 300C of the smart sign. Example 300C is an alternative embodiment to example 300B in FIG. 3B, where there are two users in the proximity of the smart sign. However, in this example, the user-specific content is separated into two distinct graphical user experiences in content windows 360a and 360b. Each content window 360 includes at least a partial view of the map from example 300A in FIG. 3A, but with only the user-specific content associated with a particular user. As described elsewhere herein, the location of each mobile communication device relative to the smart sign may be used to select which content window will display the first user-specific content and which window will display the second user-specific content. In this example, the content window 360a includes the second user-specific content for the second user and the content window 360b includes the first user-specific content for the first user.

In this illustration, the content window 360a includes the map along with icons 312a, 312c, and 312d; baggage claim icon 328; route 334; and items of interest 320, and the content window 360b includes the map along with icons 312a and 312b, gate arrow 314, route 308, and items of interest 310. In this example, each user has a personalized and unique graphical user experience with the user-specific content that is generated specifically for that respective user.

In some embodiments, each content window 360 may be a graphical user interface with which the users can interact. For example, the users may be enabled to click on the icons 312 to obtain menu information, advertisements, or other information about the various stores or restaurants. In some embodiments, the second user can click on baggage claim icon 328 to obtain status information on the baggage claim. And, in other embodiments, the first user can click on the arrow 314 to obtain gate information. Assuming the first user clicks arrow 314, the content window 360b may be modified or changed to a different screen with different user-specific content, such as what is illustrated in FIG. 3D.

FIG. 3D illustrates an example display 300D of the smart sign. Example 300D is a further illustrative embodiment of example 300C in FIG. 3C, but where the first user has selected the gate arrow to obtain additional information. In this illustration, content window 360b is modified to include gate information 340; amenities 346; and buttons 342, 344, and 348. A user can continue to interact with the smart sign by clicking on buttons 342, 344, and 348, which may allow the user to change his seat assignment, contact a gate agent, view menu items of a restaurant near the gate, or other pertinent information. As described elsewhere herein, the smart sign may provide information back to the user's mobile communication device based on these user interactions.

In various embodiments, the content that is displayed to the users may change as users enter or exit the proximity of the smart sign. Example 300E in FIG. 3E is a further illustrative embodiment of example 300D in FIG. 3D, but where a third user has entered the proximity of the smart sign. In various embodiments, the content windows may be moved, resized, or deleted depending on the interactions by the users and where additional user-specific content is to be displayed. In this example, since the first user is interacting with the first user-specific content displayed in content window 360b, content window 360b may be reduced in size, but the user-specific content unchanged, while the user-specific content in content window 360a is changed to include user-specific information for all three users. As illustrated, content window 360a now includes the map, similar to what is illustrated in example 300A in FIG. 3A, and user-specific information for all three users. In this way, the first user can continue to interact with the content window 360b, while the other users can view their respective user-specific content in content window 360a. If the first user were to exit the proximity of the smart sign, then the content window 360b may be removed and the map may be displayed similar to what is illustrated in FIG. 3A but without the first user-specific content for the first user.

It should be understood that these examples are for illustrative purposes and are not to be construed as exhaustive or limiting.

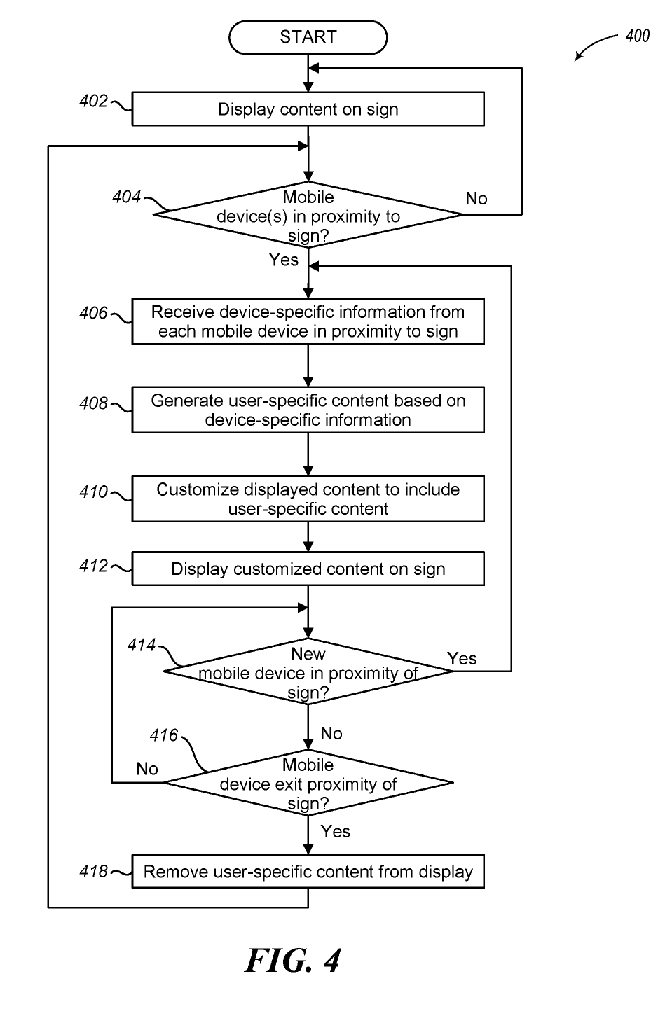

The operation of certain aspects of the disclosure will now be described with respect to FIGS. 4-7. In at least one of various embodiments, processes 400, 500, and 600 described in conjunction with FIGS. 4-7, respectively, may be implemented by or executed on one or more computing devices, such as dynamic smart sign 102.

FIG. 4 illustrates a logical flow diagram generally showing one embodiment of an overview process for providing a multi-user display on a smart sign based on the device-specific information associated with one or more mobile communication devices in close proximity to the sign in accordance with embodiments described herein.

Process 400 begins, after a start block, at block 402, where content is displayed on a smart sign, such as dynamic smart sign 102. In some embodiments, the content is stored on the smart sign. In other embodiments, the content is provided to the smart sign by a server or some other computing device.

In various embodiments, the content that is initially displayed on the smart sign, or displayed when no mobile communication devices are in its proximity, is default content for the smart sign. For example, the default content may be a map, store or restaurant information, advertisements, or other content.

Process 400 proceeds to decision block 404, where a determination is made whether there are any mobile communication devices in proximity to the smart sign. In various embodiments, the smart sign is configured to detect the presence of one or more mobile communication devices that are in proximity to the dynamic smart sign 102, such as by using a beacon or other proximity detector.

A mobile communication device is in proximity to the smart sign when the mobile communication device is within a predetermined proximity distance from the smart sign, within communication range of the smart sign via a short-range communication technology, in a predetermined location relative to the smart sign, a user of the mobile communication device is touching or otherwise interacting with the smart sign, or a combination thereof. In various embodiments, the proximity of the smart sign is pre-determined or set by an administrator based on the purpose of the smart sign, what content is being displayed on the smart sign, the location of the smart sign, or other the environmental factors associated with smart sign. In some embodiments, a mobile communication device is in proximity to the smart sign when the mobile communication device is within the visual field of display of the smart sign 102, such as the field-of-view area 204, as described elsewhere herein.

If there is one or more mobile communication devices in the proximity of the smart sign, then process 400 flows to block 406; otherwise, process 400 loops to block 402 to display the default content. Since users can move around and come and go from the proximity of the smart sign, the smart sign is periodically, continuously, or at predetermined times checking to determine if mobile communication devices have left the proximity of the smart sign or if new mobile communication devices have come in the proximity of the smart sign. Accordingly, the smart sign is dynamically determining which mobile communication devices are in proximity to the smart sign, and if there are no mobile communication devices in the proximity of the smart sign, the smart sign returns to displaying the content in a default language at block 402.

At block 406, device-specific information is received from each mobile communication device that is in the proximity of the smart sign. In various embodiments, the device-specific information from a mobile communication device includes one or more settings or information associated with that mobile communication device. Mobile communication devices can have a variety of different privacy settings that define what information the mobile communication device can provide to other devices, with or without the user's knowledge. In some embodiments, the device-specific information of the mobile communication device may be provided to the smart sign by the mobile communication device without the user's knowledge. In other embodiments, the user may have to opt in to have its mobile communication device provide its device-specific information to the smart sign.

As described elsewhere herein, the device-specific information from a mobile communication device includes demographic information of a user of the mobile communication device, interests of the user of the mobile communication device, information from or about application(s) installed or executing on the mobile communication device, or other information that personalizes the mobile communication device for the user of that mobile communication device.

In various embodiments, the smart sign may receive the device-specific information from a mobile communication device when the mobile communication device comes within communication range of the smart sign. In some embodiments, the mobile communication device may be periodically broadcasting information that can be received by other devices. The mobile communication device may be broadcasting the device-specific information itself or it may be broadcasting its identifier such that the smart sign can respond to the mobile communication device and request the device-specific information.

In other embodiments, the mobile communication device may not be broadcasting any information, but the smart sign may poll mobile communication devices that are within communication range of the smart sign to provide their device-specific information. In some embodiments, the smart sign may poll a mobile communication device for its device-specific information when a user interacts with the smart sign. In other embodiments, the smart sign may periodically transmit requests for mobile communication devices that are within communication range of the smart sign to respond to the smart sign with its device-specific information. In various embodiments, the smart sign and the mobile communication device may establish a communication link between the devices, such that the smart sign can request the device-specific information from the mobile communication device and the mobile communication device can respond to the smart sign with the device-specific information of the mobile communication device.

In various embodiments, a plurality of mobile communication devices may be determined at decision block 404 to be in proximity to the smart sign at any given point in time. The smart sign obtains or otherwise receives the device-specific information of each separate mobile communication device that is in proximity to the smart sign. Accordingly, a plurality of device-specific information (which may be the same or different from one another) are received from the plurality of mobile communication devices.

Process 400 proceeds to block 408, where user-specific content is generated for each respective user of each mobile communication device that is in proximity to the smart sign based on the respective device-specific information for the respective mobile communication device. The user-specific content may be text, graphics, symbols, video, audio, or other information or content that is personalized for a user based on the device-specific information. Examples of user-specific content can include, but is not limited to, advertisements, directions to stores or restaurants, restaurant menus, descriptive information, or other content or information. In some embodiments, the user-specific content may be separate and different from the initially displayed content. In other embodiments, the user-specific content may be the initially displayed content but personalized for that user based on the user's device-specific information.

It should be understood that the above examples are not to be limiting, but are for illustrative purposes, and virtually any content that is generated or selected based on the device-specific information may be utilized as the user-specific content.

Process 400 continues at block 410, where the displayed content is customized to include the user-specific content. In some embodiments, the user-specific content may be added to the currently displayed content, such as, for example, by adding text, icons, symbols, or other graphics to the displayed content. In other embodiments, the currently displayed content may be modified to include the user-specific content, such as, for example, by zooming in or altering a map to a desired location based on the device-specific information and highlighting the a feature on the map.

In yet other embodiments, the user-specific content may be displayed separate from the currently displayed content, such as in separate graphical user experiences or interfaces. In some embodiments, the graphical user experience for a user is a content window that includes the respective user-specific content and is separate from other content that is being displayed. In some embodiments, the user may be enabled to interact with the user-specific content, such as via a graphical user interface. In at least one embodiment, the graphical user interface may be a graphical user experience with which the user can interact.

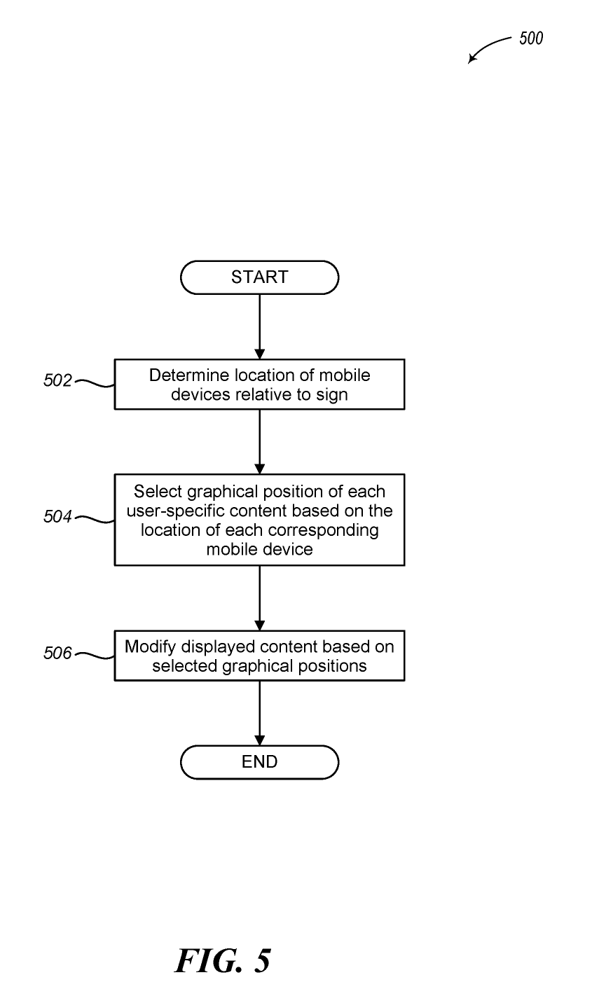

In some embodiments, a location of each respective mobile communication device may be utilized to determine how to display the user-specific content, which is described in more detail below in conjunction with FIG. 5.

It should be understood that the above examples are not to be limiting, but are for illustrative purposes, and the displayed content can be customized to include the user-specific content in virtually any manner.

Process 400 proceeds next to block 412, where the modified content is displayed on the smart sign.

Process 400 continues next at decision block 414, where a determination is made whether one or more new mobile communication devices have entered the proximity of the smart sign. In various embodiments, decision block 414 may employ embodiments of decision block 404 to determine if there is a new mobile communication device in the proximity of the smart sign. As described elsewhere herein, the mobile communication devices that are in proximity to the smart sign can change over time. Accordingly, the smart sign periodically, continuously, or at predetermined times checks to determine which mobile communication devices are in the proximity of the smart sign and if any new mobile communication devices have come in the proximity of the smart sign.

In one non-limiting example, the smart sign may receive a mobile communication device identifier from each mobile communication device that it communicates with and store it while the mobile communication device is within the proximity of the smart sign. As the smart sign checks to determine which mobile communication devices are in its proximity, if the smart sign receives any new identifiers, then those mobile communication devices are determined to be new mobile communication devices in the proximity of the smart sign.

If there is a new mobile communication device in the proximity of the smart sign, then process 400 loops to block 406 to receive device-specific information from the new mobile communication device; otherwise, process 400 flows to decision block 416.

At decision block 416, a determination is made whether a mobile communication device that was in the proximity of the smart sign has exited the proximity of the smart sign. In various embodiments, a mobile communication device may have exited the proximity of the smart sign if the smart sign is no longer in communication with the mobile communication device, if the user of the mobile communication device has stopped interacting with the smart sign, if a predetermined amount of time has lapsed, or any combination thereof. In various embodiments, the smart sign periodically, continuously, or at predetermined times checks to determine if a mobile communication device has exited the proximity of the smart sign. If a mobile communication device has exited the proximity of the smart sign, then process 400 flows to block 418; otherwise, process 400 loops to decision block 414 to continue to monitor for mobile communication devices entering or exiting the proximity of the smart sign.

At block 418, the user-specific content for the user of the mobile communication device that has exited the proximity of the smart sign is removed from the displayed content. In various embodiments, only the user-specific content for the mobile communication device that is no longer in the proximity of the smart sign is removed.

In some embodiments, the user-specific content for other users of other mobile communication devices that are still in the proximity of the smart sign may be unmodified and may continue to be displayed. In other embodiments, the format of the remaining displayed content, e.g., the default content plus the user-specific content for remaining users in proximity to the smart sign, may be adjusted based on the mobile communication device exiting the proximity of the smart sign. For example, if two users are interacting with a map, similar to what is illustrated in FIG. 3C, and a first user leaves the proximity of the smart sign, then the format of the content with the user-specific content for the second user may be adjusted to be similar to what is illustrated in FIG. 3B, such as if the first user was never in the proximity of the smart sign. It should be recognized that in some situations and embodiments, such an adjustment may not be desirable because it could negatively impact the second user's experience of the smart sign.

After block 418, process 400 loops to decision block 404 to continue to monitor if there are mobile communication devices in the proximity of the smart sign.

FIG. 5 illustrates a logical flow diagram generally showing one embodiment of a process for selecting the graphical position of user-specific content to display on the multi-user display on the smart sign in accordance with embodiments described herein. Process 500 begins, after a start block, at block 502, where a location of the mobile communication device(s) in proximity to the smart sign is determined relative to the smart sign. In various embodiments, the smart sign may utilize a variety of range and directional sensors, technologies, or mechanisms known to those skilled in the art, to determine the location of each mobile communication device relative to the smart sign. In at least one embodiment, the location of the mobile communication device may be determined based on where on the display screen of the smart sign a user touches or interacts with the smart sign. In some embodiments, the smart sign may determine the location of each mobile communication device over a period of time to determine if and in what direction and rate the mobile communication device is moving relative to the smart sign.

Process 500 continues at block 504, where a graphical display position is determined for each user-specific content based on the location of each respective mobile communication device. In various embodiments, the displayed content is modified so that the user-specific content for each corresponding user is closer to or in a display position that is logically easier for the corresponding user(s) to view or interact with relative to other users.

As mentioned above, the viewable area in front of the smart sign, or field-of-view area, may be logically separated into multiple different sections. Each logical section may be associated with a display position on the smart sign so that the rendered user-specific content is closer to the user in that section or more easily viewed based on the user's location. For example, assume the field-of-view area in front of the smart sign is logically separated into a left-viewing section and a right-viewing section from the perspective of the users viewing the smart sign, such as field-of-view-area sections 204b and 204a of FIG. 2B, respectively. User-specific content for the user in the left-viewing section is generated based on device-specific information obtained from the mobile communication device of that user and displayed on the left side of the display screen of the smart sign, and user-specific content for the user in the right-viewing section is generated based on device-specific information obtained from the mobile communication device of that user and displayed on the right side of the display screen of the smart sign, both being from the perspective of the users, such as illustrated in FIGS. 3B or 3C.

In various embodiments, the display position of the user-specific content may be based on the number of mobile communication devices that have overlapping or similar device-specific information. For example, if multiple users share device-specific information, such as both mobile communication devices having the application for the coffeehouse chain Coffee_A, then the smart sign may add the device-specific information to a central content window, such as illustrated in FIG. 3B. This may be helpful to both users, because both users may want to go to the coffeehouse and both may need to look at the map to determine its location. But if the users do not have common or overlapping device-specific information, then separate content windows or graphical user experiences or interfaces may be provided, such as illustrated in FIGS. 3C and 3D. However, embodiments are not so limited and a combination of shared content and separate content may be provided to the users, such as is illustrated in FIG. 3E.

Although the above example relies on left- and right-viewing sections, embodiments are not so limited, as further described and illustrated above in conjunction with FIGS. 2A-3C. It should be understood that the above examples are not to be limiting, but are for illustrative purposes. Other mechanisms may be utilized to determine a graphical display position for each user-specific content based on the relative location of each mobile communication device.

Process 500 continues at block 506, where the displayed content is modified based on the selected graphical positions. As described herein, the user-specific content may be positioned in separate graphical positions on the display screen of the smart sign, added to other content, or some combination thereof. Similarly, as described elsewhere, separate graphical user experiences or graphical user interfaces may be generated to include the respective user-specific content. Each graphical user experience or graphical user interface may be graphically positioned on the smart sign based on the location of the respective mobile communication devices.

After block 506, process 500 terminates or returns to a calling process to perform other actions.

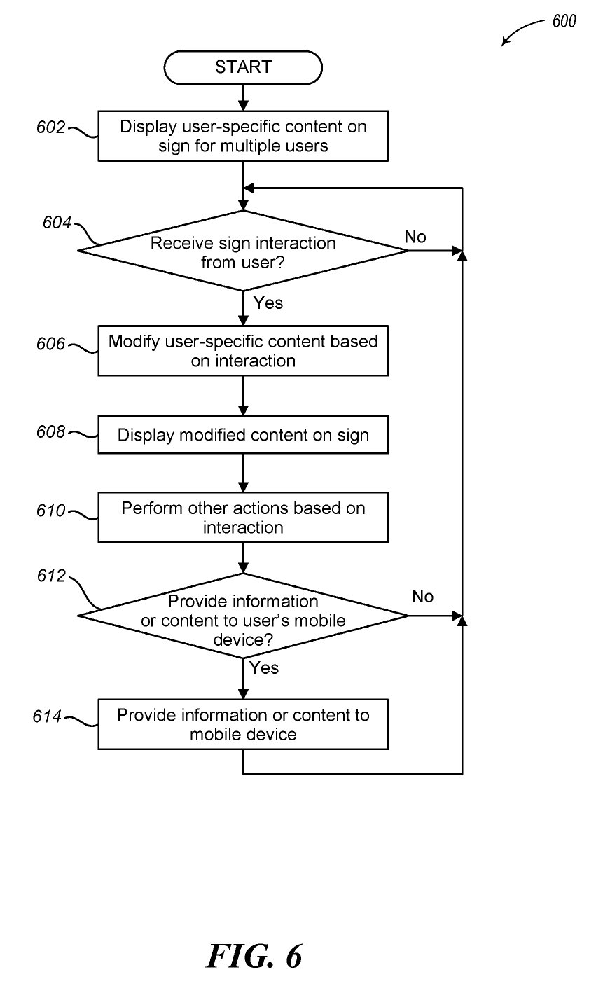

FIG. 6 illustrates a logical flow diagram generally showing one embodiment of a process for receiving user interactions with a multi-user display and performing actions based on those interactions in accordance with embodiments described herein. Process 600 begins, after a start block, at block 602, where user-specific content is displayed on a smart sign for multiple users. In various embodiments, block 602 may employ embodiments described above in conjunction with processes 400 and 500 of FIGS. 4 and 5, respectively, to determine and display user-specific content.

Process 600 proceeds to decision block 604, where a determination is made whether the smart sign has received an interaction from a user. In various embodiments, interaction by the user may be an input onto a touch screen or buttons on the smart sign, speaking to the smart sign, or other interaction. If the smart sign receives an interaction, process 600 flows to block 606; otherwise, process 600 loops to decision block 604 to continue to wait for receipt of an interaction from a user.

At block 606, user-specific content is modified based on the interaction. In various embodiments, the user-specific content displayed at block 602 may include buttons or other visual graphics with which the user can interact. If the user interacts with the user-specific content, the smart sign can respond by modifying the user-specific content. In various embodiments, the smart sign generates new or additional user-specific content. Such a modification may be based on only the user interaction or on a combination of the user interaction and the device-specific information associated with the user-specific content. For example, as illustrated in FIG. 3C, the user-specific content may include an arrow illustrating where the user's gate is located. If the user clicks on the arrow, then the smart sign may generate a new content window showing information about the gate, such as departure time and status, amenities near the gate, etc. Again, this modified user-specific content may be interactive or not.

It should be noted that some or all of the displayed content may be modified in response to the user's interactions depending on the number of users interacting with the sign, the number of mobile communication devices in the proximity of the smart sign, or other factors. For example, if there is only one user in the proximity of the sign, then the entire display may be modified to include new user-specific content. But if there is another user in the proximity of the smart sign, then only the user-specific content associated with the interaction may be modified while leaving the other user-specific content unmodified. In this way, each user in proximity of the smart sign can have a personalized experience with the smart sign without impacting the other user's experience by interacting with the smart sign.

Process 600 continues at block 608, where the modified content is displayed on the sign. As indicated above, there may be other unmodified content that is to still be displayed on the smart sign along with the modified content.

Process 600 proceeds next to block 610, where the smart sign performs other actions based on the interaction. In various embodiments, the other actions may include accessing information on a remote server or computing device, providing commands to other computing devices, etc. For example, as illustrated in FIG. 3D, the user-specific content may include various information about the gate of the user. This information may include a button that opens another interface enabling the user to change his seat. In this way, the smart sign performs other actions to communicate with the airline to adjust the user's seat. In another example, the user-specific content may be an advertisement or a restaurant menu. The user may click on the advertisement or a menu item to pre-purchase the item. It should be noted that these examples are for illustrative purposes and other actions may also be performed. In some embodiments, block 610 may be optional, and may not be performed.

Process 600 continues next at decision block 612, where a determination is made whether to provide information or content to the user's mobile communication device. In some embodiments, this determination may be based on the user interactions or what additional actions are performed by the smart sign. For example, in some embodiments, if the user utilizes the user-specific content and the smart sign to change his seat, then the smart sign may provide updated boarding pass information or a new e-ticket to the user's mobile communication device.

In other embodiments the user-specific content or the displayed content may be provided to the mobile communication device. For example, a screenshot of the user-specific content is provided to the user's mobile communication device. In this way, if a user is looking for his gate in an airport, the smart sign can provide an image of the map with the user's gate depicted on the map and the most efficient route to get there. As a result, the user can rely on the information provided to their mobile communication device rather than find another smart sign and start the entire process all over again. If additional information is to be provided to the user's mobile communication device, then process 600 flows to block 614 to provide the information or content to the mobile communication device; otherwise, process 600 loops to decision block 604 to continue to monitor for interactions by the user with the smart sign.

In various embodiments, the information provided to the mobile communication device may be stored in the memory of the mobile communication device until it is deleted by the user, until the user leaves the proximity of the sign or some other designated area, or for a predetermined period of time. In some embodiments, this information may be accessible to the user via a smart-sign application executing on the mobile communication device or via an application associated with the particular information provided. For example, if the information is updated boarding pass information, then the information may be accessible to the user via an e-ticket application.

It should be noted that a variety of different types of information or content can be provided to the user's mobile communication device based on what content or information is being displayed by the smart sign, the purpose of the smart sign, the interactions the user had with the smart sign, the additional actions performed by the smart sign, or the like.

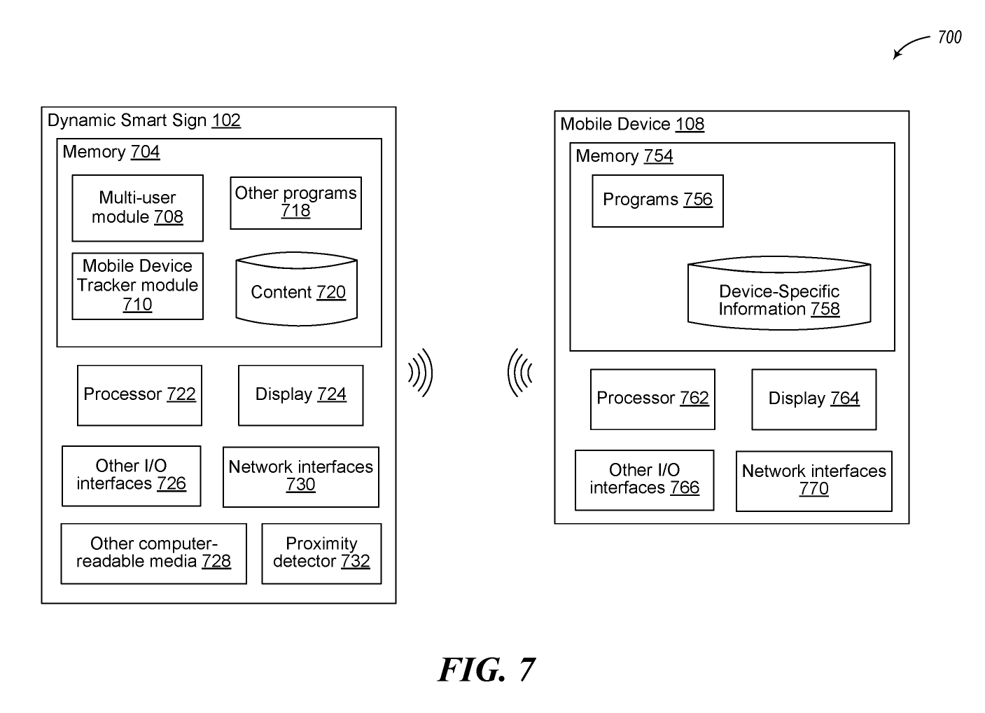

FIG. 7 shows a system diagram that describes one implementation of computing systems for implementing embodiments described herein. System 700 includes a dynamic smart sign 102.

One or more special-purpose computing systems are used to implement dynamic smart sign 102 to receive device-specific information from mobile communication devices 108 that are in close proximity to the dynamic smart sign 102, and in some embodiments generate user-specific content or modify displayed content based on the device-specific information, as described herein. Accordingly, various embodiments described herein may be implemented in software, hardware, firmware, or in some combination thereof. Dynamic smart sign 102 includes memory 704, processor 722, display 724, I/O interfaces 726, other computer-readable media 728, network interface 730, and proximity detector 732.

Processor 722 includes one or more processing devices that execute instructions to perform actions, including at least some embodiments described herein. In various embodiments, the processor 722 may include one or more central processing units (CPUs).

Memory 704 may include one or more various types of non-volatile and/or volatile storage technologies. Examples of memory 704 include, but are not limited to, flash memory, hard disk drives, optical drives, solid-state drives, various types of random access memory (RAM), various types of read-only memory (ROM), other computer-readable storage media (also referred to as processor-readable storage media), or other memory technologies, or any combination thereof. Memory 704 may be utilized to store information, including computer-readable instructions that are utilized by processor 722 to perform actions, including at least some embodiments described herein.

Memory 704 may have stored thereon various modules, such as multi-user module 708 and mobile communication device tracker module 710, or other programs 718. The mobile communication device tracker module 710 utilizes the proximity detector 732 to determine and track mobile communication devices 108 that are in close proximity to the dynamic smart sign 102. In some embodiments, the mobile communication device tracker module 710 obtains the device-specific information and a location of those mobile communication devices. The multi-user module 708 can generate user-specific content for the users of the mobile communication devices that are in proximity to the dynamic smart sign 102. In various embodiments, the multi-user module 708 performs actions to enable user interaction with the smart sign 102, such as but not limited to receiving inputs from a touch display associated with display 724 or from other I/O interfaces 726. Based on those received inputs, the multi-user module 708 can modify the content or user-specific content that is displayed on the display 724 to the users. In some embodiments, the multi-user module 708 can provide information to the mobile communication device 108 via the network interface 730.

Memory 704 may also store content 720. Content 720 may include default content as well as other content or information that can be used to generate the user-specific content.

Proximity detector 732 is a device capable of detecting the presence of one or more mobile communication devices that are in close proximity or within a predetermined range of the dynamic smart sign 102. The proximity detector 732 may be an embodiment of proximity detector 117 in FIG. 1. In some embodiments, the proximity detector 732 is configured to receive signals, such as via Near Field Communication (NFC) protocols, Bluetooth Low Energy (BLE) protocols, Radio-frequency identification (RFID) technology, or other short-range communication technologies. In some embodiments, the dynamic smart sign 102 communicates with the mobile communication devices to receive various user settings and other device-specific information from the mobile communication devices. In some embodiments, the proximity detector 732 can determine range and direction of signals from the mobile communication devices utilizing a variety of ranging techniques known to those skilled in the art. This information is used by the mobile communication device tracker module 710 to determine a location of each corresponding mobile communication device and whether the mobile communication device is moving or has exited the proximity of the dynamic smart sign 102.

Display 724 is a display device capable of rendering content to a user. The display 724 may be a liquid crystal display, light emitting diode, or other type of display device, and include a touch sensitive screen capable of receiving inputs from a user's hand, stylus, or other object.

I/O interfaces 726 may include interfaces for various other input or output devices, such as audio interfaces, other video interfaces, USB interfaces, physical buttons, or the like. Other computer-readable media 728 may include other types of stationary or removable computer-readable media, such as removable flash drives, external hard drives, or the like. Network interfaces 730 are configured to communicate with other computing devices, such as mobile communication device 108 via a communication network (not illustrated).

One or more computing systems are used to implement the mobile communication device 108 to provide device-specific information to the dynamic smart sign 102. Accordingly, various embodiments described herein may be implemented in software, hardware, firmware, or in some combination thereof. The mobile communication device 108 includes memory 754, one or more processors 762, display 764, I/O interfaces 766, and network interfaces 770.

Processor 762 includes one or more processing devices that execute instructions to perform actions. In various embodiments, the processor 762 may include one or more central processing units (CPUs).

Memory 754 may include one or more various types of non-volatile and/or volatile storage technologies. In some embodiments, memory 754 may be employ storage technology similar to what is described above for memory 704. Memory 754 may be utilized to store information, such as computer-readable instructions that are utilized by processor 762 to perform actions, including at least some embodiments described herein.

Memory 754 may have stored thereon various programs 756 and device-specific information 758. The programs 756 can include operating system programs, mobile applications, or other programs. The device-specific information 758 includes information, settings, or parameters about the mobile communication device 108, programs 756, or other stored information about a user of the mobile communication device 108. In various embodiments, the mobile communication device 108 provides the device-specific information 758 to the dynamic smart sign 102 when requested by the dynamic smart sign 102 or it may periodically broadcast some or all of the device-specific information 758, which can be captured by the dynamic smart sign 102 when the mobile communication device 108 is within communication range of the dynamic smart sign 102.

I/O interfaces 766 may include interfaces for various other input or output devices, such as audio interfaces, display interfaces, other video interfaces, USB interfaces, or the like. Network interfaces 770 are configured to communicate with other computing devices, such as dynamic smart sign 102 via a communication network (not illustrated).

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a memory that stores instructions;
a display device that displays visual content;
a proximity sensor in communication with a processor to determine when one or more mobile communication devices is in a field-of-view area of the display device;
a communication interface that communicates with the one or more mobile communication devices to receive device-specific information from each of the one or more mobile communication devices;
wherein the processor executes the instructions from the memory to perform actions, the actions including:
displaying the visual content to the display device;
determining that a first mobile communication device and a second mobile communication device are in the field-of-view area of the display device based on data received from the proximity sensor;
receiving first device-specific information from the first mobile communication device via the communication interface;
receiving second device-specific information from the second mobile communication device via the communication interface;
generating first user-specific content that is personalized for a first user of the first mobile communication device based on the first device-specific information;
generating second user-specific content that is personalized for a second user of the second mobile communication device based on the second device-specific information;
customizing the displayed visual content to include both the first user-specific content and the second user-specific content concurrently with each other; and
displaying the customized visual content on the display device.

2. The system of claim 1, wherein the processor executes the instructions to perform further actions, the further actions comprising:
receiving an interaction from the first user of the first mobile communication device;
modifying the first user-specific content for the first user in response to the received interaction without modifying the second device-specific content for the second user; and
displaying the modified first user-specific content along with the unmodified second user-specific content on the display device.

3. The system of claim 1, wherein the processor executes the instructions to perform further actions, the further actions comprising:
determining that the first mobile communication device has exited the field-of-view area of the display device; and
removing the first user-specific content for the first mobile communication device from the customized visual content while maintaining the second user-specific content for the second mobile communication device.

4. The system of claim 1, wherein the processor executes the instructions to perform further actions, the further actions comprising:
determining that a mobile communication device of the first mobile communication device and the second mobile communication device has exited the field-of-view area of the display device; and
removing the user-specific content for the mobile communication device that has exited the field-of-view area from the customized visual content.

5. The system of claim 1, wherein the processor executes the instructions to perform further actions, the further actions comprising:
determining a location of the first and second mobile communication devices relative to the display device;
determining a graphical position on the display device for the first and second user-specific content based on the location of the first and second mobile communication devices;
modifying the customized visual content to simultaneously render the first and second user-specific content on the display device based on the determined graphical position for the first and second user-specific content; and
displaying the modified customized visual content on the display device.

6. The system of claim 1, wherein customizing the displayed visual content further comprises:
generating a first graphical user experience for the first user with the first user-specific content and a second graphical user experience for the second user with the second user-specific content;
determining a location of the first and second mobile communication devices relative to the display device; and
generating the customized visual content to include the first and second graphical user experiences based on the location of the first and second mobile communication devices.

7. The system of claim 1, wherein the processor executes the instructions to perform further actions, the further actions comprising:
receiving an interaction from the first user of the first mobile communication device; and
providing information associated with the interaction to the first mobile communication device in response to receiving the interaction from the first user.

8. The system of claim 1, wherein the processor executes the instructions to perform further actions, the further actions comprising:
receiving an interaction from the first user of the first mobile communication device;
performing an action in response to receiving the interaction from the first user; and
providing information to the first mobile communication device in response to the performed action.

9. The system of claim 1, further comprising:
wherein the proximity device determines that the first mobile communication device is within the field-of-view area of the display device when the first mobile communication device is within a predetermined distance of the display device; and
wherein the processor performs further actions, comprising:
polling the first mobile communication device via the communication interface for the first device-specific information in response to the first mobile communication device being within the field-of-view area of the display device.

10. The system of claim 1, further comprising:
wherein the proximity device determines that the first mobile communication device is within the field-of-view area of the display device when the first user of the first mobile communication device interacts with the display device; and
wherein the processor performs further actions, comprising:
polling the first mobile communication device via the communication interface for the first device-specific information in response to the interaction by the first user.

11. A system, comprising:
a memory that stores visual content;
a display device that displays the visual content;
a proximity sensor; and
a processor that is in communication with the proximity sensor and receives data regarding specific mobile communication devices that are in proximity to the display device, wherein the processor performs actions, including:
receiving device-specific information from each of a plurality of mobile communication devices that are in the proximity of the display device;
generating separate user-specific content for each respective user of the plurality of mobile communication devices based on the device-specific information received from each respective mobile communication device;
customizing the visual content to include separate user-specific content for each respective user of the plurality of mobile communication devices; and
displaying the customized visual content for each of the plurality of mobile communication devices on the display device concurrently with each other.

12. The system of claim 11, wherein the processor performs further actions, comprising:
determining that a mobile communication device of the plurality of mobile communication devices has left the proximity of the display device; and
removing the user-specific content for the mobile communication device from the customized visual content while maintaining the user-specific content for those mobile communication devices that are still in the proximity of the display device.

13. The system of claim 11, wherein customizing the visual content includes:
determining a graphical position on the display device for each user-specific content based on a location of each of the plurality of mobile communication devices relative to the display device; and
generating the customized visual content to simultaneously render each user-specific content on the display device based on the determined graphical position for each user-specific content.

14. The system of claim 11, wherein providing the customized visual content includes:
providing a separate graphical user interface on the display device for each user of the plurality of mobile communication devices, wherein each separate graphical user interface includes the user-specific content for each respective mobile communication device.

15. The system of claim 11, wherein the processor performs further actions, comprising:
receiving at least one interaction with the customized visual content from a user of a mobile communication device of the plurality of mobile communication devices; and
modifying the user-specific content for the mobile communication device based on the at least one received interaction without modifying other user-specific content for other mobile communication devices in the proximity of the display device.

16. The system of claim 11, wherein the processor performs further actions, comprising:
receiving at least one interaction with the device-specific information for a mobile communication device of the one or more mobile communication devices; and
providing information associated with the at least one interaction to the mobile communication device in response to receiving the at least one interaction.

17. A method, comprising:
displaying visual content on a display screen of a smart sign;
determining that one or more mobile communication devices are in proximity to the smart sign;
receiving device-specific information from each of the one or more mobile communication devices, wherein the device-specific information for each respective mobile communication device includes information associated with an interest of a user of the respective mobile communication device;
generating user-specific content for each respective user of the one or more mobile communication devices based on the device-specific information from each respective mobile communication device;
customizing the displayed visual content to include each user-specific content for each respective user of the one or more mobile communication devices; and
displaying the customized visual content on the display screen of the smart sign.

18. The method of claim 17, wherein customizing the displayed visual content includes:
adding the device-specific information for each of the one or more mobile communication devices to the displayed visual content.

19. The method of claim 17, wherein customizing the displayed visual content includes:
modifying the displayed visual content to include the device-specific information for each of the one or more mobile communication devices.

20. The method of claim 17, wherein customizing the displayed visual content includes:
generating a graphical user interface for each separate device-specific information, wherein each graphical user interface is separate from the displayed visual content.

21. The method of claim 17, wherein customizing the displayed visual content includes:
generating a separate graphical user interface for each respective mobile communication device of the one or more mobile communication devices, wherein each graphical user interface includes the displayed visual content and the device-specific information for the respective mobile communication device.

22. The method of claim 17, further comprising:
redisplaying the visual content without the user-specific content when the one or more mobile communication devices exit the proximity of the smart sign.

23. The method of claim 17, further comprising:
determining that a mobile communication device of the one or more mobile communication devices has left the proximity of the smart sign; and
removing the user-specific content for the mobile communication device from the customized visual content while maintaining the user-specific content for those mobile communication devices that are still in the proximity of the smart sign.
